(19) United States
(12) Patent Application Publication
(10) Pub. No.: US 2017/0160989 A1
(43) Pub. Date: Jun. 8, 2017

(54) SOLID STATE DISK AND METHOD FOR IMPLEMENTING TRIM COMMAND OF THE SAME

(71) Applicant: QUANTA STORAGE INC., Taoyuan City (TW)

(72) Inventors: Jin-Shing Hsieh, Taoyuan City (TW); Yi-Long Hsiao, Taoyuan City (TW)

(21) Appl. No.: 15/247,941

(22) Filed: Aug. 26, 2016

(30) Foreign Application Priority Data
Dec. 3, 2015 (CN) 201510876173.4

(51) Int. Cl. G06F 3/06; G06F 12/02

(52) U.S. Cl. CPC G06F 3/0659; G06F 3/061; G06F 3/0679; G06F 12/0246; G06F 2212/1016; G06F 2212/152; G06F 2212/214; G06F 2212/7201

(57) ABSTRACT

A solid state drive (SSD) and a method for implementing trim commands of the SSD are provided. The SSD notifies a host that the implementing of the trim commands have been completed when the SSD just modifies deletion flags of lookup table entries based on the received trim commands. Accordingly, the duration for responding to the host is shortened. The SSD implements the trim commands, in the background, on the logical addresses where are marked by the deletion flags, such that the performance of the SSD is improved.

### BACKGROUND OF THE INVENTION

1. Field of the Invention

The present disclosure relates generally to a solid state drive (SSD), and more particularly to a method for implementing trim commands to modify a flash translation layer (FTL) when the SSD receives the trim commands from a host.

2. Description of the Prior Art

A solid state drive (SSD) is a single storage device in which a NAND flash memory array is integrated, and the SSD is usually used as a storage device of an electronic device. A host of the electronic device sends a logical address for accessing data from a central processing unit (CPU) to the SSD connected to a transmission interface. A controller installed in the SSD cooperates with a buffer to receive the logical address from the host, to access the data stored in a physical address of a flash memory array corresponding to the logical address, and to transmit the accessed data to a dynamic random access memory (DRAM) of the host. The accessed data transmitted to the DRAM would be reserved for the host.

Since the erasing times of a flash memory is limited, data would be dispersedly stored in the flash memory array. To manage the relationships between the logical addresses of data and the physical addresses of the flash memory array, the SSD would read management information of each data block in the flash memory array when the SDD starts up, so as to form a logical to physical lookup table of the data and to establish a flash translation layer (FTL) for storing and managing the logical to physical lookup table and related parameters thereof.

Data stored in the flash memory of the SSD cannot be arbitrarily overwritten. Old data should be erased before new data is stored. Moreover, the data of the flash memory is erased in unit of data blocks. The SSD utilizes a mechanism of garbage collection in unit of data blocks to move data stored in valid pages of a data block and then erase all of data stored in the data block to recycle the data block, which would be used as a spare block for storing data. Therefore, the faster the host informs the SSD about invalid pages, the easier the number of invalid pages of the data block reaches a threshold of the recycling, and the greater the efficiency of the recycling of garbage. Accordingly, enough spare blocks might be provided, data might be written without waiting for the recycled spare blocks, and the performance of the SSD might be improved.

Please refer to FIG. 1. FIG. 1 is a schematic diagram that demonstrates a solid state drive implementing trim commands according to the prior art. A trim command is a standard instruction of the prior art for improving the performance of an SSD, and the trim command should be given by a system. When the host obtains information about the invalid pages (e.g. data and files are deleted by a user), the host would inform the SSD about the invalid pages via a batch of trim commands (e.g. the trim command 1 to the trim command n shown in FIG. 1). According to the prior, each of the trim commands is usually implemented through four execution steps. In the execution step 1, the trim commands are received from the host. In the execution step 2, the logical to physical lookup table is cleared according to a range of the logical addresses of the trim commands. In the execution step 3, the parameters of the FTL are adjusted according to the range of the logical addresses of the trim commands. Finally, in the execution step 4, the host is informed about the completion of implementing the trim command. After the implementing of one of the trim commands is completed, the foresaid four execution steps would be repeated to implement another trim command until the implementing the last trim command n is completed. Accordingly, if the invalid pages of the SSD could be informed as soon as possible, the performance of the SSD would be improved.

However, according to the prior art, since the four execution steps should be executed for implementing each of the trim commands, the response time for informing the host about the completion of implementing the whole batch of the trim commands would be elongated. More particularly, if the range of the logical addresses of the trim commands is too broad and too scattered, the response time would be elongated excessively because the logic addresses accessed by the SSD are non-continuous and it needs more time for executing the execution steps 2 and 3 to clear the logical to physical lookup table and adjust the parameters of the FTL. As a result, the host would be standby for most of time, such that other operations of the host would be supplanted and the performance of the SSD would be reduced. Therefore, there is an issue needs to be solved when the SSD implementing the trim commands according to the prior art.

### SUMMARY OF THE INVENTION

It is an objective of the present invention to provide an SSD, which sets a deletion flag in a lookup table entry of the logical to physical lookup table. The deletion flag marks a logically address as a logically address without the implementing of the trim commands, such that the SSD would implement the trim commands according to the deletion flags.

It is another objective of the present invention to provide a method for implementing trim commands of an SSD. The SSD notifies a host that the implementing of the trim commands have been completed when the SSD just modifies the deletion flags of the lookup table entries based on the received trim commands. Accordingly, the duration for responding to the host is shortened.

It is another objective of the present invention to provide a method for implementing trim commands of an SSD. The SSD implements the trim commands, in the background, on the logical addresses where are marked by the deletion flags, so as to improve the performance of the SSD.

Accordingly, an embodiment of the present invention provides a method for implementing the trim commands received by a SSD. The SSD uses a controller to receive the trim commands and temporarily stores the received trim commands in a buffer. The SSD uses a flash memory array to store data, and the SSD uses a flash translation layer (FTL) unit to determine to establish the FTL either in the buffer or in the flash memory array. The FTL unit instructs the controller to read data stored in the flash memory array to form a logical to physical lookup table, so as to establish the FTL and manage parameters of the FTL. The logical to physical lookup table comprises physical addresses and lookup table entries. A deletion flag field of one bit is marked out in a reserved field of the lookup table entries. The deletion flag is configured to mark a logical address as a logical address without the implementing of the trim commands. The SSD would implement the trim commands in the background or in a standby mode according to the deletion flags.

According to an embodiment of the present invention, the SSD receives a batch of trim commands, which inform the SSD about the invalid pages of the SSD. The deletion flag of the lookup table entry of the logical to physical lookup table in each logical address located within the range of one of the trim commands is modified to mark the logical address as a logical address without the implementing of the trim commands. Then, the host is informed the implementing of the trim command is completed. After the implementing of a trim command is completed, the foresaid steps would be repeated to implement another trim command until the implementing of the last trim command is completed. For the logically addresses marked by the deletion flags as logically addresses without the implementing of the trim commands, the SSD clears the data of the lookup table entry and adjusts the parameters of the FTL in the background or in a standby mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram that demonstrates a solid state drive implementing trim commands according to the prior art.

FIG. 2 is a functional block diagram of a solid state drive according to an embodiment of the present invention.

FIG. 3 is a schematic diagram of logical to physical lookup table according to an embodiment of the present invention.

FIG. 4 is a schematic diagram of an entry of the logical to physical lookup table according to an embodiment of the present invention.

FIG. 5 is a schematic diagram that demonstrates a solid state drive implementing trim commands according to an embodiment of the present invention.

FIG. 6 is a schematic diagram that demonstrates ranges of the logical addresses of the trim commands.

FIG. 7 is a flow chart of a method for implementing trim commands of an SSD according to an embodiment of the present invention.

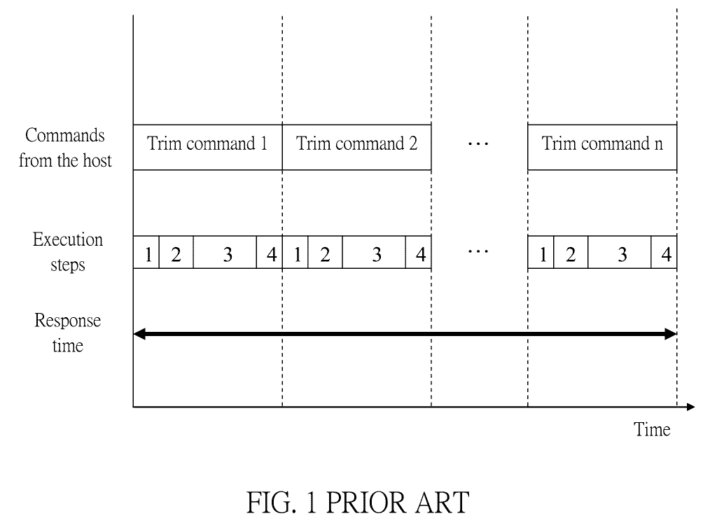

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

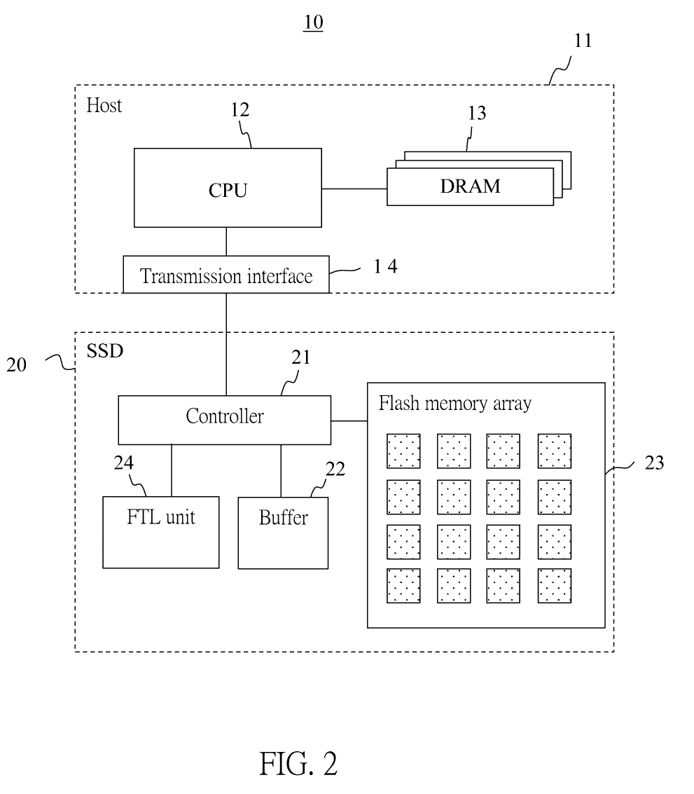

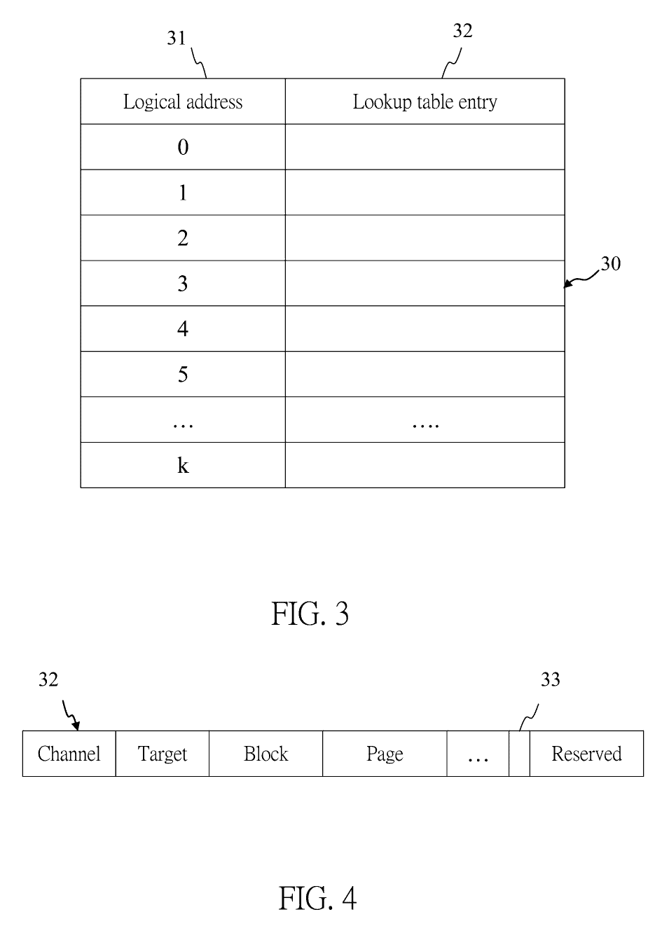

Please refer to FIG. 2, FIG. 3 and FIG. 4. FIG. 2 is a functional block diagram of a solid state drive (SSD) 10 according to an embodiment of the present invention. FIG. 3 is a schematic diagram of a logical to physical lookup table 30 according to an embodiment of the present invention. FIG. 4 is a schematic diagram of an entry 32 of the logical to physical lookup table 30 according to an embodiment of the present invention. The SSD 20 in FIG. 2 is a storage device of an electronic device 10. A host 11 of the electronic device 10 has a central processing unit (CPU) 12 and dynamic random access memory (DRAM) 13. The CPU 12 cooperates with the DRAM 13 to send logical addresses for accessing data to the SSD 20, which is coupled to a transmission interface 14. The access commands from the host 11 and received by a controller 21 are temporarily stored in a buffer 22, so as to order the controller 21 to access data stored in physical addresses, which are corresponding to the logical addresses, of a flash memory array 23. The accessed data would be transmitted to the DRAM 13 of the host 11 and reserved for the host 11. The SSD 20 further comprises a flash translation layer (FTL) unit 24 configured to establish a flash translation layer (FTL) when the SSD 20 starts up and to manage parameters of the FTL.

When the SSD 20 starts up, the FTL unit 24 determines to establish the FTL either in the buffer 22 or in the flash memory array 23, and the FTL unit 24 instructs the controller 21 to read management information of each data block in the flash memory array 23 to form the logical to physical lookup table 30 in FIG. 3. The logical to physical lookup table 30 comprises logical addresses 31 and lookup table entries 32. One of the lookup table entries 32 is illustrated in FIG. 4 and comprises a plurality of fields, such as a cannel field, a target field, a block field, a page field, a reserved field, etc., for recording related parameters of the entry. Accordingly, when the controller 21 receives a command from the host 11, the FTL unit 24 uses the logical to physical lookup table 30 to compare the physical address in the flash memory array 23 with the block and the page recorded by the lookup table entry 32 according to the logical address of the command, such that the command would be quickly implemented in corresponding flash memory cells. The SSD 20 uses the lookup table entries 32 to mark out a deletion flag field 33 of one bit, each of which is configured to mark a logical address as a logical address without the implementing of the trim commands, such that the SSD would implement the trim commands in the background or in a standby mode according to the deletion flags. In the embodiment, the deletion flag field 33 is set in the reserved field of the lookup table entry 32.

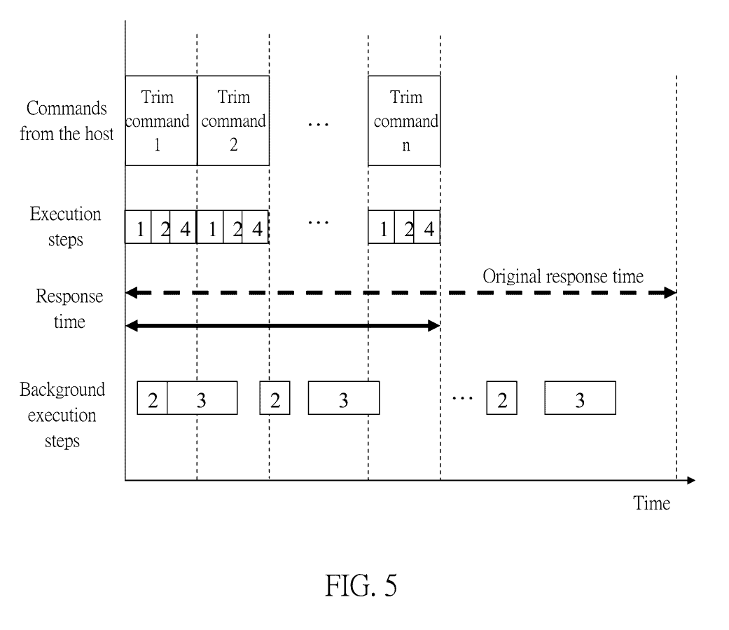

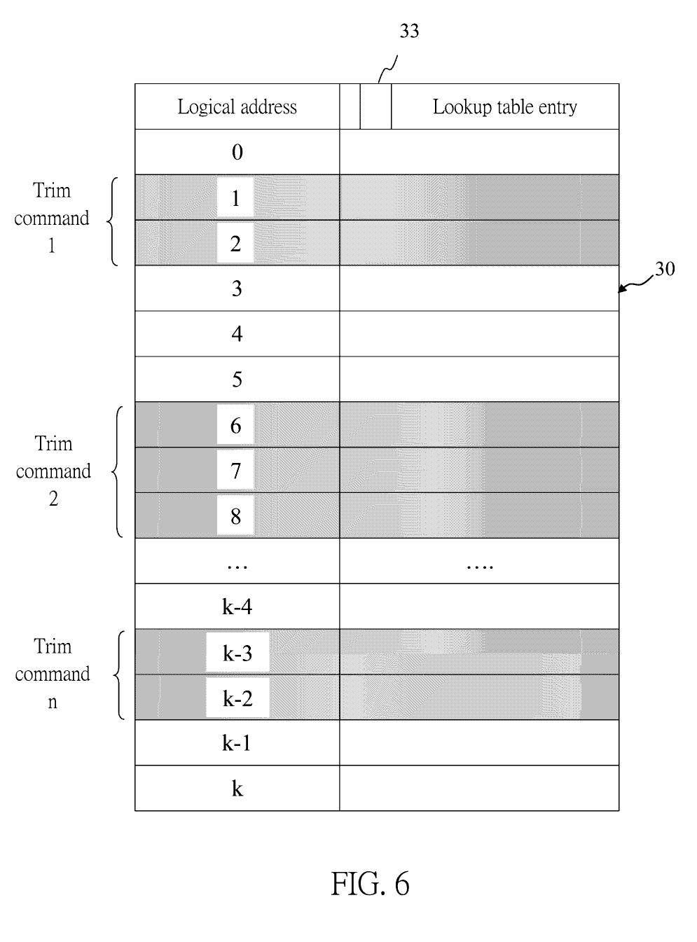

Please refer to FIG. 5 and FIG. 6. FIG. 5 is a schematic diagram that demonstrates a solid state drive implementing trim commands according to an embodiment of the present invention. FIG. 6 is a schematic diagram that demonstrates ranges of the logical addresses of the trim commands. In FIG. 5, the SSD receives a batch of trim command 0 to trim command n from the host, such that the SSD is informed about the invalid pages. According to the present invention, three executions steps are executed for implementing each of the trim commands. In the execution step 1, one of the trim commands is received from the host. In the execution step 2, the deletion flag 33 of a lookup table entry of the logical to physical lookup table in each logical address located within the range (labeled as shadow in FIG. 6) of the trim command is modified to mark the logical address as a logical address without the implementing of the trim commands. In the execution step 2, the data recorded in the lookup table entry would not be cleared, and meanwhile the execution step 3 for adjusting the parameters of the FTL would not be executed. Then, the execution step 4 is executed immediately to inform the host the implementing of the trim command has been completed. And then, the foresaid three execution steps would be repeated to implement another trim command until the implementing of the last trim command n is completed. Accordingly, because the SSD of the present invention merely modifies the deletion flag 33 in the execution step 2 without executing the execution step 3 for adjusting the parameters of the FTL, the response time for informing the host about the completion of implementing the whole batch of the trim commands would be shortened.

As for the logical address, in which no trim command has been implemented, because the host is informed the data page in the logical address is an invalid page, the host would not request to access the data page. Although only the deletion flag is modified, the data page is still valid in view of the SSD, such that the number of invalid pages of each data block would not increase to influence the performance of the mechanism of garbage collection of the SSD. As long as the spare blocks of the SSD are enough to maintain the normal operations of the SSD, it has no urgency to implement the trim commands. Therefore, according to the present invention, the SSD might, selectively in the background or in a standby mode, execute the procedure of clearing the data of the lookup table entry in the execution step 2 and the procedure of adjusting the parameters of the FTL in the execution step 3 for the logically addresses marked by the deletion flags as logically addresses without the implementing of the trim commands. Meanwhile, because the host would not wait for the completion of implementing the trim commands, such that the time and speed of executing other operations of the SSD would not be influenced and that the performance of the SSD would be improved.

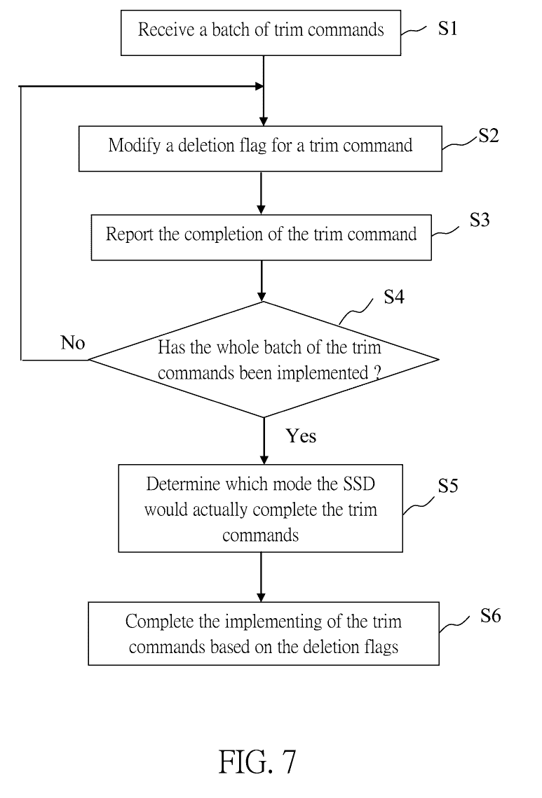

Please refer to FIG. 7. FIG. 7 is a flow chart of a method for implementing trim commands of an SSD according to an embodiment of the present invention. The detailed description of steps that the SSD implements the trim commands according to the present invention is provided as follows. In step S1, the SSD receives a batch of trim commands, which inform the SSD about the invalid pages of the SSD, from the host. In step S2, the deletion flag of the lookup table entry of the logical to physical lookup table in each logical address located within the range of one of the trim commands is modified to mark the logical address as a logical address without the implementing of the trim commands. In step S3, the host is informed the implementing of the trim command is completed. In step S4, it is determined whether the whole batch of trim commands has been implemented. If not the whole batch of trim commands has been implemented, step S2 would be repeated to implement a next trim command. If the whole batch of trim commands has been implemented, step S5 is executed to determine the SSD would actually finish the implementing of the trim commands in the background or in a standby mode. In step S6, for the logically addresses marked by the deletion flags as logically addresses without the implementing of the trim commands, the SSD clears the data of the lookup table entry and adjusts the parameters of the FTL.

Therefore, a SSD of the present invention sets a deletion flag by using the lookup table entry of the logical to physical lookup table. According to the method of the present invention for implementing the trim commands, the SSD notifies a host that the implementing of the trim commands have been completed when the SSD just modifies the deletion flags of the lookup table entries according to the logical addresses of the received trim commands. Therefore, the duration for responding to the host is shortened. Moreover, according to the method of the present invention, the SSD might, selectively in the background or in a standby mode, implement of the trim commands on the logically addresses marked by the deletion flags as logically addresses without the implementing of the trim commands, such that the time and speed of executing other operations of the SSD would not be influenced and that the performance of the SSD would be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solid state disk, comprising:
a controller, receiving trim commands from a host;
a buffer, storing the trim commands received by the controller;
a flash memory array, configured to storing data; and
a flash translation layer unit, configured to instruct the controller to read data stored in the flash memory array to form a logical to physical lookup table, so as to establish a flash translation layer (FTL) and manage parameters of the FTL;
wherein the logical to physical lookup table comprises physical addresses and lookup table entries, and a deletion flag field is marked out in the lookup table entries and is configured to mark logical addresses as logical addresses without implementing of the trim commands.

2. The solid state disk of claim 1, wherein the deletion flag field is a one-bit field.

3. The solid state disk of claim 1, wherein the deletion flag field is marked out in a reserved field of the lookup table entries.

4. The solid state disk of claim 1, wherein the SSD implements the trim commands in background or in a standby mode according to logically addresses marked by deletion flags in the deletion flag field as logically addresses without implementing of the trim commands.

5. The solid state disk of claim 1, wherein the flash translation layer unit determines to establish the FTL either in the buffer or in the flash memory array.

6. A method for implementing a trim command of a solid state disk, the method comprising:
receiving the trim command;
modifying a deletion flag of a lookup table entry of a logical to physical lookup table of the SSD in each logical address located within a range of the trim command;
informing a host about completion of implementing the trim command; and
implementing the trim command, in background or in a standby mode, on the logical addresses marked by the deletion flag.

7. The method of claim 6, wherein the trim command is configured to inform the SSD about invalid pages of the SSD.

8. The method of claim 6, wherein the deletion flag is configured to mark a logical address as a logical address without implementing of the trim command.

9. The method of claim 6, wherein the trim command implemented in background is configured to clear data recorded by the lookup table entry and modify parameters of a flash translation layer (FTL) of the SSD.

10. The method of claim 6, wherein a batch of trim commands are received, and steps for modifying, informing and implementing are repeated until implementing of a last trim command of the batch is completed.
